(19) United States
(12) Patent Application Publication
(10) Pub. No.: US 2005/0147952 A1
(43) Pub. Date: Jul. 7, 2005

(54) Learning apparatus

(76) Inventors: Michael Morris, Norwalk, CT (US); William Derraugh, Weston, CA (US)

Correspondence Address: TOPE-MCKAY & ASSOCIATES, 23852 PACIFIC COAST HIGHWAY #311, MALIBU, CA, 90265, US

(21) Appl. No.: 10/752,044

(22) Filed: Jan. 5, 2004

(51) Int. Cl. G09B 5/00

(52) U.S. Cl. 434/311

(57) ABSTRACT

The present invention relates to a learning apparatus, and more particularly, to a learning apparatus with a housing that includes a means for storing and producing a sound stored therein. The learning apparatus further comprises an interchangeable learning card with a hole therethrough and a means for activating in operable communication with the means for storing and producing a sound. The location of the hole on the card corresponds to a location of the means for activating such that when the interchangeable learning card is attached with the housing, the hole on the card permits a user to activate a desired means for activating, resulting in a sound being produced.

### FIELD OF INVENTION

The present invention relates to a learning apparatus, and more particularly, to a learning apparatus with a housing that includes a means for storing and producing a sound stored therein, and an interchangeable learning card that corresponds with the sound stored.

### BACKGROUND OF INVENTION

Learning tools have long been known in prior art. With advances in sound recording technology, educationally minded innovators have devised a myriad of sound-producing teaching tools. Several learning tools have been invented that correlate a sound with a learning card.

U.S. Pat. No. 5,556,283, issued to Stendardo et al., teaches using coded pictorial cards in conjunction with a housing to form audible sounds. The Stendardo patent discusses a card specifically coded to be read by a coded key switch assembly.

U.S. Pat. No. 3,648,385, issued to Barlow et al., discloses use of a phonograph card, where the card has actual phonograph grooves on one side and graphic matter on an opposite side.

U.S. Pat. No. 4,237,624, issued to Yeh et al., teaches using a magnetic tape that is mounted on a flexible card or sheet. The card is then guided across an electromagnetic transducer head to be read.

U.S. Pat. No. 4,245,404, issued to Yoshinari, teaches using a card with an image on one surface and a magnetic track containing audio contents on an opposite surface.

U.S. Pat. No. 4.980,919, issued to Tsai, teaches a language practice set whereby a user can store voice signals into a memory with different addresses, using a message card with different coding holes. When the card in the Tsai Patent is inserted into a housing, the housing reads the presence or absence of particular coding holes and produces a corresponding voice signal.

U.S. Pat. No. 3,696,525, issued to Cleary, discloses a teaching machine having three display panels on which visual information can be presented by means of a teaching card. As in the patents issued to Yoshinari and Yeh, the teaching card in the Cleary Patent uses magnetic tracks containing prerecorded audio messages.

U.S. Pat. No. 4,465,465, issued to Nelson, teaches a communication device suitable for use by a handicap person. The communication device contains visual cards with corresponding buttons. When the buttons are pushed, the communication device emits an audible message corresponding to the visual card. Although the device produces a result similar to that of the present invention, the buttons in the Nelson Patent are separated from the visual cards as a separate paddle.

U.S. Pat. No. 4,019,263, issued to Sakuma, discloses a teaching apparatus in which a teaching card has visual information and a magnetically recorded band. As is the case with the Yoshinari, Yeh, and Cleary Patents, the teaching card in the Sakuma Patent includes a magnetic recording medium.

U.S. Pat. No. 4,664,634, issued to Cutler et al., discloses a teaching apparatus having a visual information card. Once again, the visual information card in the Cutler Patent card includes a recorded sound mechanism.

U.S. Pat. No. 4,681,548, issued to Lemelson, teaches an apparatus having an information card. As is the case with several previously mentioned patents, the card in the Lemelson Patent includes a coded readable medium.

While all aforementioned patents contain an information card, none contain a simple, yet efficient information card having a means for activating hole without a readable medium included therein.

Therefore, it can be appreciated that there exists a continuing need for a new and improved learning apparatus with 1) a housing that includes a means for storing and reproducing a sound stored therein, 2) a means for activating the means for storing and reproducing a sound to produce a stored sound, and 3) an interchangeable learning card having a hole therethrough, with the location of the hole on the card corresponding to a location of a means for activating of the housing. In this regard, the present invention substantially fulfills this need.

### SUMMARY OF INVENTION

The present invention relates to a learning apparatus, and more particularly, to a learning apparatus with a housing. The housing comprises a means for storing and reproducing a sound stored therein, a means for activating the means for storing and reproducing a sound to produce a stored sound, and a means for detachably attaching an interchangeable learning card thereto. The learning apparatus further comprises an interchangeable learning card having a hole therethrough. The location of the hole on the card corresponds to a location of a means for activating of the housing, such that when the interchangeable learning card is attached with the housing, the hole on the card permits a user to manually depress a desired means for activating, resulting in a sound being produced.

In another aspect, the sound being produced corresponds to a theme of the interchangeable learning card, thus correlating audio data stored in the housing with visual data on the learning card.

Additionally, the hole on the card is selected from a group consisting of an actual die cut hole and a pliable membrane.

In yet another aspect, the learning apparatus further comprises a trigger attached with the housing, whereby insertion of the interchangeable learning card actuates the trigger and changes the learning apparatus from an “OFF” to an “ON” position.

In another aspect, the learning apparatus further comprises an interchangeable sound chip in operable communication with the means for storing and reproducing a sound, whereby the interchangeable sound chip changes the sound corresponding to a particular theme.

In a final aspect, the learning apparatus further comprises a packaging clip removably attached with a backside of the housing, whereby the packaging clip can be used to hold an interchangeable learning card.

### BRIEF DESCRIPTION OF THE DRAWINGS

The nature of the learning apparatus described herein will be readily apparent in the following drawings, in which:

FIG. 1A is a top perspective view of an unassembled housing according to the present invention, and means for activating therein;

FIG. 1B is a top perspective view of an assembled housing;

FIG. 2A is a top perspective view of an interchangeable learning card being attached with the housing;

FIG. 2B is a top perspective view of an interchangeable learning card attached with the housing;

FIG. 3A is bottom perspective view of an unassembled housing; and

FIG. 3B is a bottom perspective view of an assembled housing.

### DETAILED DESCRIPTION

The present invention relates to a learning apparatus, and more particularly, to a learning apparatus with a housing that includes a means for storing and producing a sound stored therein, and an interchangeable learning card that corresponds with the stored sound.

The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

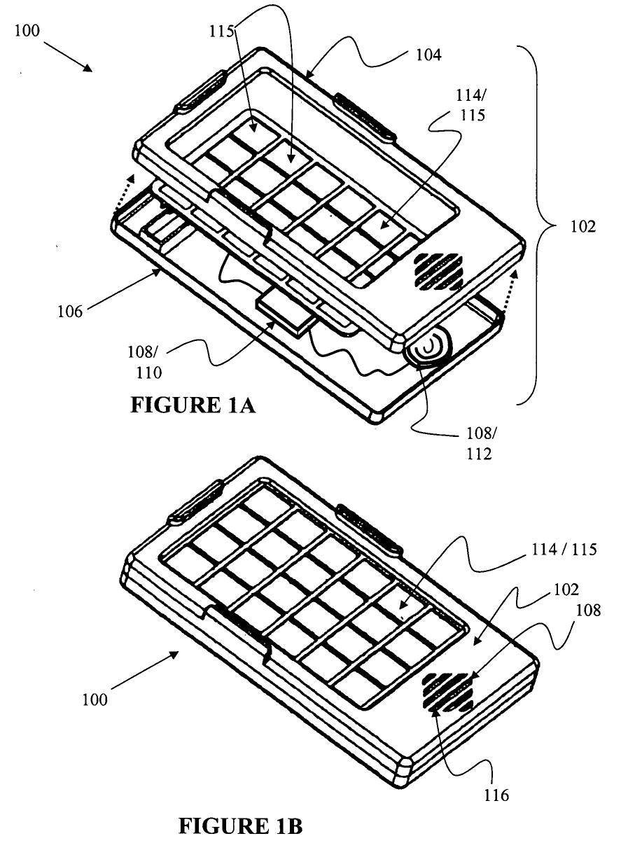

FIG. 1A illustrates a learning apparatus 100 with an unassembled housing 102. The housing 102 may be any suitable configuration. For example, the housing 102 may comprise a top part 104 and a bottom part 106, or alternatively, may be constructed of one piece of material. The housing 102 may be constructed of any suitably rigid material, non-limiting examples of which include plastic, metal, and paperboard. The housing 102 includes a means for storing and reproducing a sound 108 stored therein. The means for storing and reproducing a sound 108 may be any suitable sound storing and reproducing device or mechanism, non-limiting examples include a memory chip 110 attached with a speaker 112. A means for activating 114 the means for storing and reproducing a sound 108 is operably connected with the means for storing and reproducing a sound 108. The means for activating 114 may be any suitable mechanism or device for completing an electrical circuit, non-limiting examples of which include a button and a switch.

FIG. 1B illustrates a learning apparatus 100 with an assembled housing 102. When assembled, the means for activating 114 may be utilized to interact with the means for storing and reproducing a sound 108, thereby producing a stored sound. The housing 102 may optionally include a plurality of means for activating 115. Each means for activating in the plurality of means for activating 115 corresponds with a different sound being produced by the means for storing and reproducing a sound 108. The housing 102 may also optionally include sound holes 116, where a produced sound may escape from an interior of the housing 102 and to a user's ears.

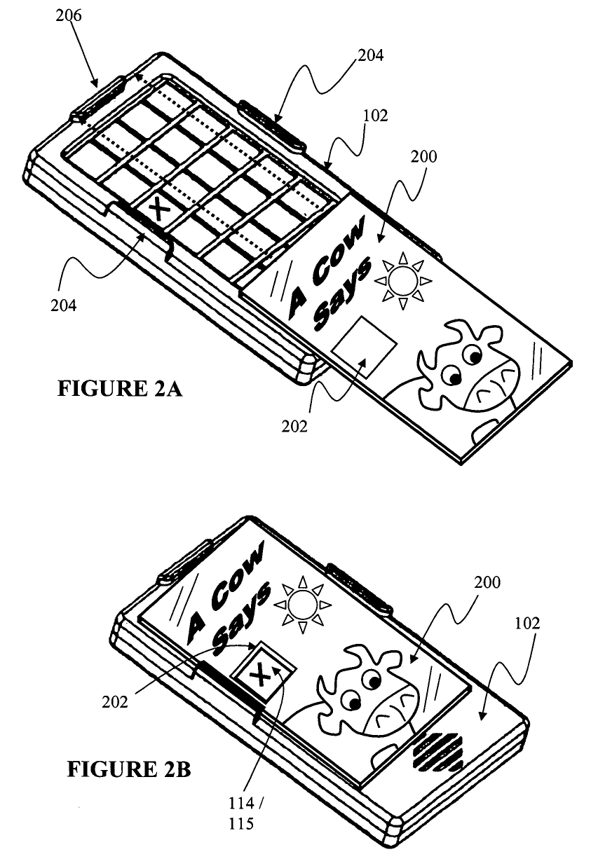

FIG. 2A illustrates an interchangeable learning card 200 with a hole 202 therethrough, being attached with the housing 102. The interchangeable learning card 200 may be any suitable card containing information thereon. For example, the interchangeable learning card 200 may contain information suitable for teaching a child to associate a picture or object with a sound. The hole 202 may be any suitable type of hole, non-limiting examples of which include an actual die-cut hole and a pliable membrane.

The housing 102 further includes a means for detachably attaching 204 the interchangeable learning card 200. The means for detachably attaching 204 the interchangeable learning card 200 may be any suitable mechanism or device for detachably attaching a board-like object, non-limiting examples of which include clips, snaps and rails. The housing 102 may also optionally include a trigger 206. The trigger 206 is attached with the housing 102, such that insertion of the interchangeable learning card 200 actuates the trigger 206 and changes the learning apparatus 100 from an “OFF” BWIOIO LEARNING APPARATUS to an “ON” position. The trigger 206 may be any suitable mechanism or device for closing a circuit, a non-limiting example of which includes an electrical switch.

FIG. 2B illustrates the interchangeable learning card 200 attached with the housing 102. The hole 202 on the interchangeable learning card 200 corresponds to a location of a means for activating 114 of the housing 102. When the interchangeable learning card 200 is attached with the housing 102, the hole 202 on the interchangeable learning card 200 aligns with the means for activating 114, permitting a user to activate a desired means for activating 114 that results in a sound being produced. The sound being produced may be any suitable sound. For example, the sound being produced may correspond to a particular theme, object or picture located on the interchangeable learning card 200. Each interchangeable learning card 200 includes a hole 202 located at a different location. Through changing the interchangeable learning card 200, the hole 202 aligns with a different means for activating 114 in the plurality of means for activating 115, and accordingly, with a different sound because each means for activating 114 corresponds with a different sound.

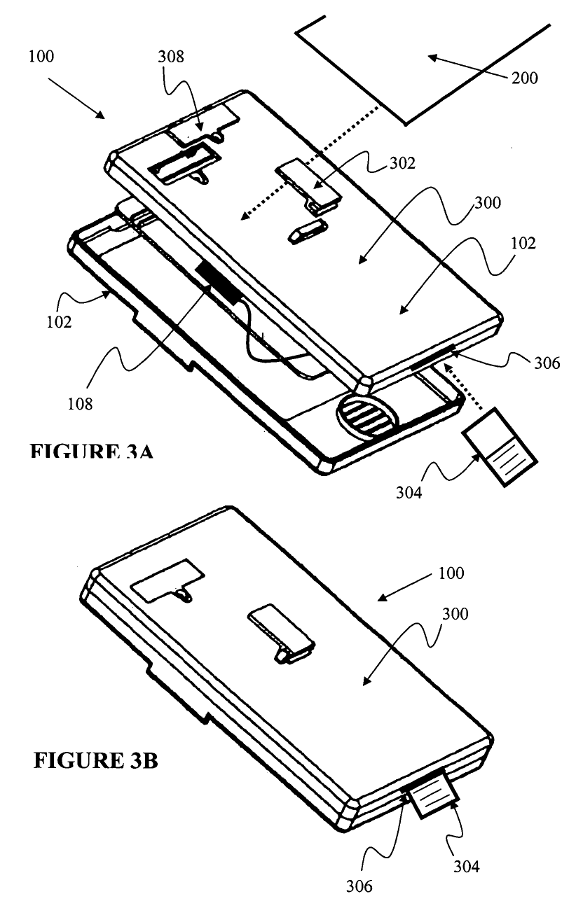

FIG. 3A illustrates a backside 300 of the learning apparatus 100 with an unassembled housing 102. The learning apparatus 100 may further include a packaging clip 302. The packaging clip 302 is removably attached with the backside 300 of the housing 102. The packaging clip 302 may be any suitable mechanism or device for holding the interchangeable learning card 200, a non-limiting example of which includes a plastic L-shaped clip.

Additionally, the learning apparatus 100 may optionally include an interchangeable sound chip 304. The interchangeable sound chip 304 may be any suitable sound memory-storing device. When inserted in a sound chip opening 306, the interchangeable sound chip 304 is in operable communication with the means for storing and reproducing a sound 108. Additionally, the sound chip opening 306 may be located at any suitable location on the housing for insertion of the interchangeable sound chip 304.

When the interchangeable sound chip 304 is attached with the learning apparatus 100, it changes a sound corresponding to a particular theme. The interchangeable sound chip 304 may be added with the learning apparatus 100 in order to add additional sounds corresponding with additional interchangeable learning cards 200. When the interchangeable sound chip 304 is removed, the learning apparatus 100 will revert to the original sounds stored on the means for storing and reproducing a sound 108.

As an electrical device, the learning apparatus 100 operates on any suitable form of electricity, a non-limiting example of which includes batteries. Through time and usage, the batteries may lose their energy and need replacing. Therefore, the learning apparatus 100 may contain a removably attached battery cover 308. Upon removing the battery cover 308, a user may easily replace the discharged batteries and continue to utilize the learning apparatus 100.

FIG. 3B illustrates the backside 300 of an assembled learning apparatus 100. As further illustrated in FIG. 3B, the interchangeable sound chip 304 may be inserted in the sound chip opening 306.

1. A learning apparatus, comprising:
a. a housing including:
i. a means for storing and reproducing a sound stored therein;
ii. a means for activating the means for storing and reproducing a sound to produce a stored sound; and
iii. a means for detachably attaching an interchangeable learning card thereto; and
b. an interchangeable learning card having a hole therethrough, with the location of the hole on the card corresponding to a location of a means for activating of the housing such that when the interchangeable learning card is attached with the housing, the hole on the card permits a user to manually activate a desired means for activating, resulting in a sound being produced.

2. A learning apparatus as set forth in claim 1, wherein the sound being produced corresponds to a theme of the interchangeable learning card, thus correlating audio data stored in the housing with visual data on the learning card.

3. A learning apparatus as set forth in claim 2, wherein the hole on the card is selected from a group consisting of an actual die cut hole and a pliable membrane.

4. A learning apparatus as set forth in claim 3, further comprising a trigger attached with the housing, whereby insertion of the interchangeable learning card actuates the trigger and changes the learning apparatus from an “OFF” to an “ON” position.

5. A learning apparatus as set forth in claim 4, further comprising a interchangeable sound chip in operable communication with the means for storing and reproducing a sound, whereby the interchangeable sound chip changes the sound corresponding to a particular theme.

6. A learning apparatus as set forth in claim 5, further comprising a packaging clip removably attached with a backside of the housing, whereby the packaging clip can be used to hold an interchangeable learning card.

7. A learning apparatus as set forth in claim 1, wherein the hole on the card is selected from a group consisting of an actual die cut hole and a pliable membrane.

8. A learning apparatus as set forth in claim 1, further comprising a trigger attached with the housing, whereby insertion of the interchangeable learning card actuates the trigger and changes the learning apparatus from an “OFF” to an “ON” position.

9. A learning apparatus as set forth in claim 1, further comprising a interchangeable sound chip in operable communication with the means for storing and reproducing a sound, whereby the interchangeable sound chip changes the sound corresponding to a particular theme.

10. A learning apparatus as set forth in claim 1, further comprising a packaging clip removably attached with a backside of the housing, whereby the packaging clip can be used to hold an interchangeable learning card.
